(19) United States
(12) Patent Application Publication
(10) Pub. No.: US 2024/0238780 A1
(43) Pub. Date: Jul. 18, 2024

(54) MICRO-ANALYSIS CHIP

(71) Applicant: CANON KABUSHIKI KAISHA, Tokyo (JP)

(72) Inventors: FUKA ENOKIDO, Kanagawa (JP); MAKOTO FUKATSU, Shizuoka (JP); JUN MIURA, Kanagawa (JP); MASANORI TANAKA, Kanagawa (JP); HARUNOBU MAEDA, Tokyo (JP); KATSUICHI ABE, Kanagawa (JP); AKIHISA MATSUKAWA, Tokyo (JP); YASUKAZU IKAMI, Tokyo (JP); Keiji Miyazaki, Tokyo (JP); TAKESHI YAMAMOTO, Kanagawa (JP)

(21) Appl. No.: 18/618,408

(22) Filed: Mar. 27, 2024

Related U.S. Application Data
(63) Continuation of application No. PCT/JP2022/035098, filed on Sep. 21, 2022.

(30) Foreign Application Priority Data
Sep. 28, 2021 (JP) 2021-158508

(51) Int. Cl. B01L 3/00; G01N 27/333

(52) U.S. Cl. CPC B01L 3/5023; B01L 3/502715; G01N 27/333; B01L 2300/0645; B01L 2300/126; B01L 2400/0406

(57) ABSTRACT

An object is to provide a micro-analysis chip with which stable ion concentration measurement can be performed without increasing a chip size or prolonging a measurement time. In order to achieve this object, the following micro-analysis chip is provided. That is, provided is a micro-analysis chip when an average areal velocity which is an area of a region that a specimen has permeated during a period until a dispensed specimen reaches a reference electrode is represented by V1, and when an average areal velocity which is an area of a region that the specimen has permeated during a period until the dispensed specimen fills an inside of a first channel chamber after the dispensed specimen has reached the reference electrode is represented by V2, the average areal velocity V1 and the average areal velocity V2 satisfy a relationship of V1>V2.

### CROSS-REFERENCE TO RELATED APPLICATIONS

This application is a Continuation of International Patent Application No. PCT/JP2022/035098, filed Sep. 21, 2022, which claims the benefit of Japanese Patent Application No. 2021-158508, filed Sep. 28, 2021, both of which are hereby incorporated by reference herein in their entirety.

### FIELD OF THE INVENTION

The present invention relates to a micro-analysis chip having a microchannel formed in a porous substrate.

### BACKGROUND OF THE INVENTION

### Description of the Related Art

In recent years, a micro-analysis chip that can perform analysis in biochemistry in one chip efficiently through utilization of a microsize fine channel has been attracting attention in a wide variety of fields. Specifically, the development has been attracting attention in the respective fields of, for example, medicine, drug discovery, healthcare, environment, and food as well as biochemical research.

In the former half of 1990s, a micro-analysis chip for performing the pretreatment, stirring, mixing, reaction, and detection of a sample on one chip was developed by forming a fine channel of a micron size on glass or silicon through use of, for example, a photolithography method or a die. As a result, the downsizing of a test system and an increase in analysis speed thereof, and a reduction in amount of a specimen or a waste liquid were achieved.

Electrochemical analysis is analysis of measuring a potential between electrodes immersed in a specimen to be analyzed, and is widely used in fields of medicine and environment. A conventional electrochemical analysis is performed by a technical expert through use of advanced equipment, and hence fields and resources for performing the measurement are restricted to some extent. However, there are needs for a micro-analysis chip for electrochemical analysis that is inexpensive, easy to handle, and disposable for use in, for example, developing countries, remote places, and disaster sites which have insufficient medical equipment, and an airport where the spread of an infectious disease is required to be prevented at the border.

In electrochemical analysis, such as quantification of electrolyte ions in a solution, a reference electrode which is capable of maintaining a constant potential and having a stable potential is required. A glass electrode which has been hitherto utilized as the reference electrode is expensive. In addition, an internal fluid is required, and hence it has been not easy to achieve downsizing. Moreover, when the glass electrode is stored, the glass electrode is required to be stored in a concentrated solution of ions used in the glass electrode. Thus, handling thereof has not been easy.

In U.S. Patent Application Publication No. 2016/033438, there is proposed a device including a micro-analysis chip which is capable of measuring potential difference through use of a porous substrate, which enables the electrochemical measurement to be performed with low cost, easy handleability, and high disposability. The above-mentioned device includes one or more working electrodes and one reference electrode on the porous substrate. When measurement is performed, both electrodes are required to be electrically connected to each other in a fluid. It is described that in order to obtain a stable potential in the reference electrode, a highly concentrated aqueous solution of KCl is dispensed as a reference solution to a reference electrode region including the reference electrode when measurement is performed.

Further, in Nipapan Ruecha, Orawon Chailapakul, Koji Suzuki and Daniel Citterio, ‘Fully Inkjet-Printed Paper-Based Potentiometric Ion-Sensing Devices,’ Analytical Chemistry Aug. 29, 2017 published, 89, pp. 10,608-10,616, there is proposed a filter-paper-based measurement device for concentrations of Na ions and K ions. This device has a such a configuration that this device has a dispensing section to which a specimen is to be dispensed, and the dispensed specimen permeates from the dispensing section to a region of each of the working electrode and the reference electrode. In order to obtain a stable potential in the reference electrode in this device, there has been proposed a device in which a KCl ion crystal is deposited on the reference electrode. When measurement is performed, KCl dissolves into the specimen so that Cl ions in the reference electrode region are kept at a high concentration. Thus, a stable potential of the reference electrode is obtained.

However, when measurement is performed, the reference electrode and the working electrode are electrically connected to each other through the specimen. In this case, it is possible that KCl on the reference electrode is diffused to the working electrode through the specimen to affect the potential of the working electrode. Accordingly, it causes a problem regarding accuracy in potentiometry.

As a method for solving this problem, it is conceivable to employ a method of increasing a distance between the reference electrode and the working electrode, but this method causes an increase in chip size and an increase in entire measurement time, and thus causes another problem from a viewpoint of downsizing and cost. Accordingly, it is required to prolong a time period required until KCl is diffused to the working electrode after the start of measurement, without changing a time period required until the specimen reaches the reference electrode from the dispensing section and the measurement is started.

### SUMMARY OF THE INVENTION

One aspect of the present disclosure has an object to provide a micro-analysis chip with which influence on a working electrode due to backflow of ions from a reference electrode to a working electrode can be suppressed and stable ion concentration measurement can be performed without increasing a chip size or prolonging a measurement time.

According to one aspect of the present disclosure, there is provided a micro-analysis chip including a porous substrate having provided therein a channel wall, the channel wall forming: a dispensing section to which a specimen is to be dispensed; a first channel chamber; a second channel chamber; a first channel connecting the dispensing section and the first channel chamber to each other; and a second channel connecting the dispensing section and the second channel chamber to each other, wherein the first channel chamber has a reference electrode arranged therein, the reference electrode having a surface on which an ion crystal having specimen solubility and containing a chloride ion is arranged, wherein the second channel chamber has a working electrode arranged therein, and wherein the micro-analysis chip is configured so that, when an average areal velocity which is an area of a region that the specimen has permeated per unit time in a surface of the porous substrate during a period until the dispensed specimen reaches the reference electrode is represented by V1, and when an average areal velocity which is an area of a region that the specimen has permeated per unit time in the surface of the porous substrate during a period until the dispensed specimen fills an inside of the first channel chamber after the dispensed specimen has reached the reference electrode is represented by V2, the average areal velocity V1 and the average areal velocity V2 satisfy a relationship of V1>V2.

Further features of the present invention will become apparent from the following description of exemplary embodiments with reference to the attached drawings.

### BRIEF DESCRIPTION OF THE DRAWINGS

FIG. 1 is a simplified top view for illustrating a channel configuration of a micro-analysis chip (P1) according to Example 1-1.

FIG. 2 is a simplified sectional view along the cross section AA of FIG. 1.

FIG. 3A is a simplified top view for illustrating anisotropy of a porous substrate.

FIG. 3B is a simplified sectional view along the cross section BB of FIG. 3A.

FIG. 3C is a simplified sectional view along the cross section CC of FIG. 3A.

FIG. 4 is a simplified top view for illustrating a channel configuration of a micro-analysis chip (P11) according to Comparative Example 1.

FIG. 5 is an image diagram for illustrating a behavior of a specimen in Comparative Example 1.

FIG. 6 is an image diagram for illustrating a behavior of a specimen in Example 1-1.

FIG. 7 is a simplified top view for illustrating a channel configuration of a micro-analysis chip (P2) according to Example 1-2.

FIG. 8 is a simplified top view for illustrating a channel configuration of a micro-analysis chip (P3) according to Example 1-3.

FIG. 9 is a simplified top view for illustrating a channel configuration of a micro-analysis chip (P4) according to Example 1-4.

FIG. 10 is a simplified top view for illustrating a channel configuration of a micro-analysis chip (P5) according to Example 2-1.

FIG. 11 is a simplified top view for illustrating a channel configuration of a micro-analysis chip (P6) according to Example 2-2.

FIG. 12 is a simplified top view for illustrating a channel configuration of a micro-analysis chip (P7) according to Example 2-3.

FIG. 13 is a simplified top view for illustrating a channel configuration of a micro-analysis chip (P8) according to Example 2-4.

FIG. 14 is a simplified sectional view for illustrating the channel configuration of the micro-analysis chip (P8) according to Example 2-4.

FIG. 15 is a simplified top view for illustrating a channel configuration of a micro-analysis chip (P9) according to Example 3.

FIG. 16 is a simplified top view for illustrating a channel configuration of a micro-analysis chip (P10) according to Example 4.

### DESCRIPTION OF THE EMBODIMENTS

An exemplary embodiment of the present invention is described below with reference to the drawings. The following embodiment is illustrative, and the present invention is not limited to the contents of the embodiment. In addition, in the following respective drawings, constituents that are not required for the description of the embodiment are omitted from the drawings.

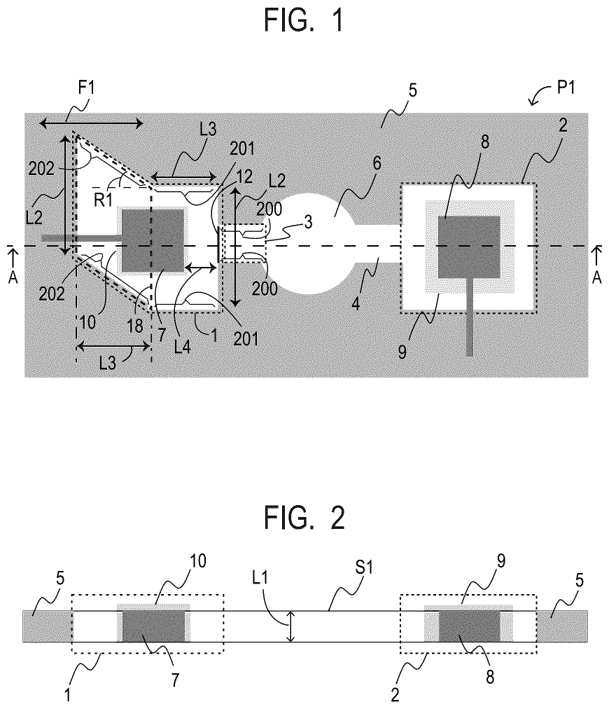

FIG. 1 simply shows a top view of a micro-analysis chip P1.

FIG. 2 simply shows a sectional view along the cross section AA of the micro-analysis chip P1, in which a lead wire of a reference electrode 7 is omitted.

The micro-analysis chip P1 includes a porous substrate S1 having provided therein a channel wall 5. The channel wall 5 forms a dispensing section 6 to which a specimen is to be dispensed, a channel chamber 1 (first channel chamber), a channel chamber 2 (second channel chamber), a channel 3 (first channel), and a channel 4 (second channel). The channel 3 connects the dispensing section 6 and the channel chamber 1 to each other, and the channel 4 connects the dispensing section 6 and the channel chamber 2 to each other.

The reference electrode 7 is arranged in the channel chamber 1, and the reference electrode 7 is covered with an ion crystal 10 having specimen solubility.

A working electrode 8 is arranged in the channel chamber 2, and the working electrode 8 is covered with an ion-selective membrane 9 having ion selectivity.

After a specimen T1 is dispensed to the dispensing section 6, the specimen T1 reaches the channel chamber 1 and flows to a permeable region (un-permeated region) until the channel chamber 1 is filled with the specimen T1. When the permeable region (un-permeated region) remains inside of the channel chamber 1 including the reference electrode 7 after the specimen T1 has reached the reference electrode 7 from the dispensing section 6, flow of the specimen T1 to the dispensing section 6 side on which the specimen T1 has already permeated (that is, backflow) is less liable to occur. Accordingly, as a time period required for the specimen T1 to fill the channel chamber 1 becomes larger, the timing at which the specimen T1 containing high-concentration ions starts to flow backward to the channel chamber 2 can be more delayed.

As a configuration of the channel chamber 1 for prolonging the time period required for the specimen T1 to fill the channel chamber 1, it is conceivable to employ a configuration of increasing a volume of the channel chamber 1 in which the specimen T1 is not yet permeated when the specimen T1 has reached the reference electrode 7 in the channel chamber 1. Specifically, for example, it is conceivable to employ a configuration of increasing an area of the channel chamber 1 by connecting a new channel chamber to the channel chamber 1.

However, in the present disclosure, from a viewpoint of, for example, reduction in size of the micro-analysis chip and reduction in amount of the ion crystal arranged on the reference electrode 7, the prolonging of the time period required for the specimen T1 to fill the channel chamber 1 has been achieved without increasing a volume of the channel.

Specifically, in the present disclosure, the channel chamber 1 is configured so that, when an average areal velocity which is an area of a region that the specimen has permeated per unit time in a surface of the porous substrate during a period until the dispensed specimen reaches the reference electrode 7 is represented by V1, and when an average areal velocity which is an area of a region that the specimen has permeated per unit time in the surface of the porous substrate during a period until the dispensed specimen fills an inside of the channel chamber 1 after the dispensed specimen has reached the reference electrode 7 is represented by V2, V1 and V2 satisfy a relationship of V1>V2.

Now, Examples and Comparative Examples are shown to specifically describe the micro-analysis chip of the present disclosure. The micro-analysis chip of the present disclosure is not limited only to the configurations embodied by Examples. Further, various numerical values of a thickness, a length, etc. are also not limited to the following values. Further, for example, when a total amount of ions in the specimen is measured, the ion-selective membrane 9 is not always required. In addition, in the following respective drawings, structural members that are not required for the description of Examples are omitted from the drawings.

### <Permeation Anisotropy of Porous Substrate>

The micro-analysis chip P1 was formed on the porous substrate S1. The porous substrate S1 includes a plurality of pores, and each of the pores can define a major axis and a minor axis. The porous substrate S1 has anisotropy.

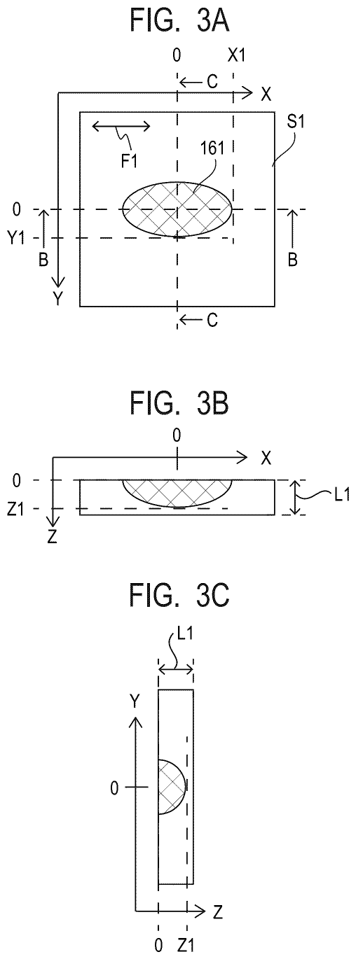

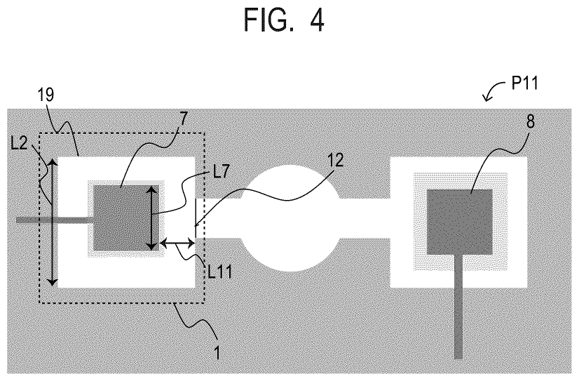

With reference to FIG. 3A to FIG. 3C, the permeation anisotropy of the porous substrate S1 is described.

In FIG. 3A to FIG. 3C, an X axis, a Y axis, and a Z axis perpendicularly intersect with each other.

FIG. 3A shows an XY plane parallel to a top surface of the porous substrate S1, FIG. 3B shows an XZ plane (B-B cross section) perpendicular to the XY plane, and FIG. 3C shows a YZ plane (C-C cross section) perpendicular to the XY plane.

When a predetermined time period has elapsed from dispensing of the specimen T1 to a point of (X, Y)=(0, 0) illustrated in FIG. 3A, as illustrated in FIG. 3A to FIG. 3C, a permeation shape 161 of the specimen T1 had an approximate shape of a shape obtained by cutting a prolate spheroid into half along its major axis. The prolate spheroid means a solid of revolution obtained by rotating an ellipse around its major axis as a rotary axis.

A major axis direction (X axis direction) of the ellipse and a fiber direction F1 of fibers forming the porous substrate match each other.

A permeation speed of the specimen in the major axis (X axis) direction of the prolate spheroid is represented by VX, a permeation speed of the specimen in a minor axis (Y axis) direction thereof is represented by VY, and a ratio of the permeation speed in the major axis to that in the minor axis (=VX/VY) is regarded as a permeation ratio E1. The level of the permeation anisotropy of the porous substrate can be represented by this permeation ratio E1.

### <Moving Direction of Specimen>

The specimen dispensed to the porous substrate moves not only in the X direction and the Y direction, but also in the Z direction.

However, the porous substrate in the present disclosure has a small thickness (Z direction) as compared to a channel length or a channel width (X direction and Y direction), and hence, after an elapse of several seconds from the dispensing of the specimen T1, a “moving direction of the specimen T” becomes synonymous with a “direction in which the specimen T moves in parallel to the XY plane.”

In the porous substrate having a channel and a channel chamber formed therein, after the dispensed specimen reaches a wall surface of the channel and a wall surface of the channel chamber, the specimen starts to be spread along those wall surfaces, and the “moving direction of the specimen T” becomes parallel to those wall surfaces.

### Example 1

In Examples 1-1 to 1-4, in order to set the average areal velocity V1 and the average areal velocity V2 to satisfy the relationship of V1>V2, a first average angle r1 and a second average angle r2 described below are set to satisfy a relationship of r1<r2.

### <Fiber Direction>

As illustrated in FIG. 3A to FIG. 3C, in a case in which the specimen is dispensed to the porous substrate in which no channel wall is formed, when the permeation shape 161 formed on the surface of the porous substrate by the dispensed specimen is an ellipse, the major axis direction (X axis direction) of the ellipse 161 is regarded as the fiber direction of the porous substrate.

The moving direction of the specimen during a period until the specimen reaches the reference electrode from the dispensing section is a moving direction while the specimen permeates the first channel and a moving direction while the specimen permeates a first region of a first channel chamber described below.

The moving direction of the specimen after the specimen has reached the reference electrode is a moving direction while the specimen permeates a second region of a first channel chamber described below.

### <First Region of First Channel Chamber and Second Region of First Channel Chamber>

In a micro-analysis chip in which a channel wall is formed in the porous substrate, a region which is a part of a region inside of the first channel chamber and is closer to the dispensing section with respect to the reference electrode is referred to as “first region of first channel chamber,” and a region other than the first region of the first channel chamber is referred to as “second region of first channel chamber.”

As an example, a micro-analysis chip P1 illustrated in FIG. 2 is described.

In a case of the micro-analysis chip P1 illustrated in FIG. 2, a region from a channel connection portion 12 to the reference electrode 7 inside of the channel chamber 1 is the first region of the first channel chamber, and the remaining region inside of the channel chamber 1 is the second region of the first channel chamber.
First region of first channel chamber: a rectangle region having a vertical length L2 and a horizontal length L4.
Second region of first channel chamber: a region obtained by adding: a “rectangle region having a vertical length L2 and a horizontal length (L3−L4)” (region in which a distance from the channel connection portion 12 is L4 or more and L3 or less); and a “parallelogram region having a bottom-side length L2 and a height L3” (region in which the distance from the channel connection portion 12 is L3 or more and (L3+L3) or less).

In the case of the micro-analysis chip P1 illustrated in FIG. 2, as described above, the second region of the first channel chamber is formed of the “rectangle region” and the “parallelogram region.”

<First Average Angle r1 and Second Average Angle r2>

An average value of an “angle formed between the fiber direction and a wall surface direction parallel to a wall surface defining the first channel” and an “angle formed between the fiber direction and a wall surface direction parallel to a wall surface defining the first region of the first channel chamber” is represented by the first average angle r1 (0°≤r1≤90°), and an average value of an “angle formed between the fiber direction and a wall surface direction parallel to a wall surface defining the second region of the first channel chamber” is represented by the second average angle r2 (0°≤r2≤90°).

As an example, the micro-analysis chip P1 illustrated in FIG. 2 is described.

In a case of the micro-analysis chip P1 illustrated in FIG. 2, the first average angle r1 and the second average angle r2 are as follows.
First average angle r1: an average value of an “angle formed between the fiber direction F1 and a wall surface direction parallel to a wall surface 200 defining a channel 3 (first channel)” and an “angle between the fiber direction F1 and a wall surface direction parallel to a wall surface 201 defining the first region of the first channel chamber.”
Second average angle r2: an average value of an “angle formed between the fiber direction F1 and a wall surface direction parallel to the wall surface 200 defining the second region of the first channel chamber” and an “angle between the fiber direction F1 and a wall surface direction parallel to a wall surface 202 defining the second region of the first channel chamber.”

In the example illustrated in FIG. 2, the fiber direction F1 and the wall surface direction parallel to the wall surface 200 defining the channel 3 are parallel to each other, and the fiber direction F1 and the wall surface direction parallel to the wall surface 201 defining the first region of the first channel chamber are parallel to each other.

Accordingly, the first average angle r1 is 0°.

In the example illustrated in FIG. 2, the angle formed between the fiber direction F1 and the wall surface direction parallel to the wall surface 202 defining the second region of the first channel chamber is represented by R1.

Accordingly, the second average angle r2 is an average value of: an angle (=0°) formed between the fiber direction F1 and a wall surface direction parallel to the wall surface 201 defining the “rectangle region having the vertical length L2 and the horizontal length (L3−L4)” in the second region of the first channel chamber; and an angle (=R1) formed between the fiber direction F1 and a wall surface direction parallel to the wall surface 202 defining the “parallelogram region having the bottom-side length L2 and the height L3” in the second region of the first channel chamber. The second average angle r2 is calculated by the following equation:

$$\begin{matrix}r 2 = ( 0 \times ( L 3 - L 4 ) + R 1 \times L 3 ) / ( L 3 - L 4 + L 3 ) = \\ R 1 \times L 3 / ( 2 \times L 3 - L 4 ) .\end{matrix}$$

### <Porous Substrate>

In Examples and Comparative Examples described below, a porous substrate S1 having the permeation ratio E1 of 2, a thickness L1 of 0.08 mm, and a porosity ε1 of 50% was used.

In this Example, paper was used as the porous substrate S1, but the porous substrate S1 is not limited to paper. The porous substrate S1 may have therein a porous structure, such as an open cell structure or a network structure including a nanofiber structure, and may be formed with use of resin, glass, an inorganic substrate, cloth, metal paper, or the like as long as the porous substrate S1 is configured to cause a capillary action with respect to liquid. Further, the permeation ratio E1 caused by anisotropy, the thickness L1, and the porosity ε1 of the porous substrate S1 are also not limited to the above-mentioned values.

With reference to FIG. 1 and FIG. 2, Example 1-1 is more specifically described.

### <Method of Forming Channel Pattern>

A hydrophobic resin G1 arranged on the porous substrate S1 was heated so that the molten hydrophobic resin was caused to permeate inside of paper and was fixed. Thus, a channel pattern was formed as the channel wall 5 that the specimen T1 was impermeable.

However, the method of forming the channel pattern is not limited thereto. For example, a method of cutting the porous substrate S1 to leave only the channel shape may be adopted. As another method, the channel wall may be formed by a wax printer.

### Example 1-1

### <Shapes and Sizes of Channels and Channel Chambers>

The channel pattern includes a dispensing section 6 to which a specimen T1 is caused to adhere, a channel chamber 1 including a reference electrode 7, a channel chamber 2 including a working electrode 8, a channel 3 connecting the dispensing section 6 and the channel chamber 1 to each other, and a channel 4 connecting the dispensing section 6 and the channel chamber 2 to each other. A width L2 of the channel chamber 1 was set to 9 mm.

The channel 3 was arranged so as to be parallel to the fiber direction F1 of the porous substrate S1.

Further, the channel chamber 1 includes a bent portion 18 shaped as a parallelogram (L2=9 mm, L3=4.5 mm, and angle R1 with respect to the fiber direction F1 of R1=45°). The bent portion 18 is arranged on a side opposite to the dispensing section 6, from a position at which a distance L3 from the channel connection portion 12 at which the channel chamber 1 and the channel 3 are connected to each other is 4.5 mm. A volume C1 of the channel chamber 1 that the specimen T1 was permeable was set to 10 μL.

Further, in the channel chamber 1, a size, a shape, a bending angle R1 (0°≤R1≤90°), and a distance L3 from the channel connection portion 12 to the bent portion 18 are not limited to the above-mentioned values. The volume C1 is only required to fall within a range that allows a saturated solution to be obtained when the ion crystal 10 to be described later is dissolved in pure water having a volume equivalent to the volume C1 and is not limited to the above-mentioned value. It is preferred that the volume C1 is maximum in the above-mentioned range from a viewpoint of backflow suppression.

### <Formulation of Electrodes>

The channel chamber 1 includes the reference electrode 7 containing Ag/AgCl as a main component at a position having a distance L4 of 1 mm from a channel connection portion 12. The reference electrode 7 includes, as a contact when measurement is performed, a lead wire formed by continuously extending the electrode from the inside of the channel chamber 1 onto the channel wall 5. Further, the KCl ion crystal 10 of 3.5 mg was arranged substantially uniformly in the entire region of the surface of the reference electrode 7 inside of the channel chamber 1.

Similarly, the working electrode 8 containing PEDOT:PSS (dispersion of polyethylenedioxythiophene and polystyrene sulfonate) as a main component was formed continuously on the channel wall 5 from the inside of the channel chamber 2. The working electrode 8 also includes a lead wire formed by continuously extending the electrode from the inside of the channel chamber 2 onto the channel wall 5. Further, inside of the channel chamber 2, the ion-selective membrane 9 that was able to select K ions was formed at a position and size capable of covering the entire region of the surface of the working electrode 8.

The ion-selective membrane 9 is formed from the following materials.
Valinomycin as an ion-selective material: 1.0 wt %
Potassium tetrakis(4-chlorophenyl)borate as an anion eliminator: 0.5 wt %
Nitrophenyl octyl ether: 65.0 wt %
Polyvinyl chloride: 33.5 wt %

It should be understood that shapes, sizes, materials, etc. of the reference electrode 7, the working electrode 8, and the ion-selective membrane 9 are not limited to those as described above.

Further, the material of the ion crystal 10 is only required to contain Cl ions, and is not limited to KCl. Moreover, the mass of the ion crystal 10 to be arranged is only required to fall within a range of the mass that becomes a saturated solution when the ion crystal 10 is dissolved in pure water having a volume equivalent to the volume C1, and is not limited to 3.5 mg.

### <Permeation of Specimen at Time of Measurement>

An area of a region that the specimen has permeated per unit time in the surface of the porous substrate inside of the channel chamber 1 is referred to as “areal velocity.” A time period T1 required for the specimen to reach one end of the reference electrode 7 on the dispensing section side (end positioned at the distance L4 from the channel connection portion 12) from the dispensing section 6 and an area S1 of the region that the specimen has permeated are measured, and the areal velocity calculated with use of the following equation is regarded as an “average areal velocity V1.” Further, a time period T2 from when the specimen reaches the reference electrode 7 to when the permeation of the specimen inside of the channel chamber 1 stops and an area S2 of the region that the specimen has permeated during this time period are measured so that the areal velocity calculated with use of the following equation is regarded as an “average areal velocity V2.”

$$V 1 = S 1 / T 1$$

$$V 2 = S 2 / T 2$$

In the micro-analysis chip P1 having the above-mentioned channel configuration, the specimen T1 dispensed to the dispensing section 6 permeates along the channel 3. The phrase “permeates along the channel 3” means that the specimen permeates in parallel to the channel wall defining the channel 3. The wall surface 201 defining the channel 3 and the fiber direction F1 of the porous substrate S1 are parallel to each other. Accordingly, the permeation direction (moving direction) of the specimen T1 until the specimen T1 reaches the reference electrode 7 and the fiber direction F1 of the porous substrate S1 match each other.

Meanwhile, after the specimen T1 reaches the reference electrode 7, in a range in which the channel is bent (bent portion 18), the permeation direction (moving direction) of the specimen T1 becomes parallel to the wall surface 202 defining the bent portion 18. That is, the permeation direction (moving direction) of the specimen T1 is inclined by 45° with respect to the fiber direction F1 of the porous substrate S1.

The permeation of the specimen T1 is caused by the capillary action. When the specimen T1 permeates along the fiber direction F1 of the porous substrate S1, an air gap between the fibers is regarded as a tubular pore, and a pore radius “a” (cm) is expressed by the following equation (1) based on the Lucas-Washburn equation.

A viscosity of a solution (specimen) is represented by “η” (P), a length of the pore is represented by “h” (cm), a surface tension of the solution is represented by “γ” (dyne/cm), a contact angle is represented by Θ (rad), and a time required for permeation of the specimen is represented by “t” (second).

The contact angle means an angle (angle present inside of liquid) formed at a location at which a free surface of the solution (specimen) is brought into contact with a surface of a fiber (fiber that forms an air gap that may be regarded as a tubular pore), between a liquid surface of the solution (specimen) and this surface of the fiber.

$$a = \frac{2 η {h}^{2}}{γ cosθ} \frac{1}{t} \qquad Equation ( 1 )$$

In the porous substrate S1, when an anisotropy is high or the angle formed between the moving direction of the specimen T1 and the fiber direction F1 is close to 0, a tubular space formed by the pore has a linear shape. Meanwhile, when an anisotropy is low or the angle R1 formed between the moving direction of the specimen T1 and the fiber direction F1 is 1.7 degrees or more and 90 degrees or less, the moving of the specimen permeating a tubular space formed by the pore is hindered by the wall surface of the channel or the channel chamber, and thus the specimen cannot continuously permeate the same tubular space. The specimen is required to pass through a pore having a direction different from the fiber direction F1 and permeate while moving to another adjacent tubular space. Accordingly, the space that the specimen T1 permeates is not one tubular space but a plurality of tubular spaces. Accordingly, with reference to the equation (1), a time “t” required for the permeation is increased and the permeation speed of the specimen T1 is decreased.

When an angle formed between the major axis direction of the permeation shape of the specimen (fiber direction F1) and the moving direction of the specimen is represented by “r” (0°≤r≤90°), and when an average value of the angle until the specimen reaches the reference electrode 7 from the dispensing section 6 is represented by r1 and an average value of the angle after the specimen has reached the reference electrode 7 is represented by r2, the average value r1 and the average value r2 satisfy a relationship of r1<r2, and thus the average areal velocity V1 and the average areal velocity V2 satisfy the relationship of V1>V2.

In this case, r1 is also referred to as an average value of an angle formed between the fiber direction F1 and a moving direction of the specimen until the specimen first reaches the reference electrode 7 from the dispensing section 6, and r2 is also referred to as an average value of an angle formed between the fiber direction F1 and a moving direction of the specimen on a side which is farther from the dispensing section than the one end of the reference electrode 7 that the specimen first reaches. The moving direction of the specimen is also referred to as a direction in which a head of the specimen moves.

### Effects of Example 1-1

In this Example, as described above, the porous substrate S1 has anisotropy in which the dispensed specimen T1 is spread in an ellipse shape with the ratio of a length of the major axis to a length of the minor axis of 2. Accordingly, when the fiber direction F1 is regarded as 0°, the velocity of the specimen moving in the direction of 45° with respect to the fiber direction F1 inside of the bent portion 18 becomes about 0.63 times smaller than the velocity of the specimen moving in the direction of 0°. A time period required for filling a channel without a bend, which has the same volume as that of the bent portion 18 of the micro-analysis chip P1, is 60 seconds. In this case, the average areal velocity in the channel without a bend is about 0.27 [mm²/second]. In contrast, in the bent portion 18 of the micro-analysis chip P1, the specimen is required to permeate at least in the direction of 45° in order to permeate the entire region, and hence the average areal velocity becomes about 0.18 [mm²/second]. Thus, the time period required for filling the bent portion 18 is about 95 seconds.

The specimen T1 flows to the permeable region until the channel chamber is filled with the specimen T1. While the permeable region remains inside of the channel chamber 1 even after the specimen T1 reaches the reference electrode 7, the flow of the specimen T1 to the channel 3 and the dispensing section 6 in which the specimen T1 has already permeated is less liable to occur. Accordingly, as the time period required for the specimen T1 to fill the channel chamber 1 becomes larger, the time period required until the specimen T1 containing high-concentration KCl starts to flow backward to the channel chamber 2 can be prolonged. In this Example, a time period required until the backflow may occur can be extended by about 35 seconds as compared to the channel having the same volume C1.

### Comparative Example 1

FIG. 4 shows a micro-analysis chip P11 according to Comparative Example 1. The micro-analysis chip P11 has the same configuration as that of the micro-analysis chip P1 regarding channels or components other than the channel chamber 1. Further, the micro-analysis chip P11 has a configuration in which the channel chamber 1 has no bent portion, and hence V1>V2 is not satisfied unlike the description of Example 1-1. The micro-analysis chip P11 has a channel configuration satisfying V1=V2.

In the micro-analysis chip P11, after a specimen T1 reached a channel connection portion 12, the specimen T1 reached a reference electrode 7 and a working electrode 8 after an elapse of about 34 seconds, and then measurement was started. Then, about 120 seconds were required from when the measurement was started to when the potential to be measured had less variation and became stable and the measurement was ended.

Meanwhile, the specimen T1 filled the channel chamber 1 after an elapse of about 86 seconds from when the specimen T1 reached the reference electrode 7 and the working electrode 8 and the measurement was started. After the channel chamber 1 was filled with the specimen T1, 25 seconds were required until KCl on the reference electrode 7 closest to the working electrode 8 flowed backward toward the working electrode 8 and reached the working electrode 8.

Accordingly, after the specimen T1 reached the channel connection portion 12, 154 (=34+120) seconds in total were required until the measurement was ended, but KCl flowing backward reached the working electrode after 145 (=34+86+25) seconds in total. Accordingly, the KCl concentration in the working electrode 8 slightly changed before the measurement was ended, and thus the measurement was not able to be performed accurately.

In Example 1-1, the average areal velocity V2 is smaller than the average areal velocity V1. Thus, the time period from when the specimen reaches the reference electrode to when the measurement is ended is 120 seconds similarly to the micro-analysis chip P11, and no increase in the time period from the measurement start to the measurement end is caused. Meanwhile, the bent portion 18 causes the time period required for the specimen T1 to fill the channel chamber 1 to be extended by about 35 seconds, and thus the specimen T1 fills the channel chamber 1 after an elapse of about 121 seconds from when the specimen T1 reaches the reference electrode 7. Accordingly, KCl flowing backward reaches the working electrode 8 after an elapse of 180 seconds from when the specimen T1 reaches the channel connection portion 12. Thus, the measurement can be ended while the stable condition is maintained, before KCl flows backward to reach the working electrode 8.

Table 1 shows the average areal velocity, an end time of measurement, a reaching time of backflow, etc. in Example 1-1 and Comparative Example 1.

TABLE 1

| | | | | | Reaching | |
|---|---|---|---|---|---|---|
| | Average areal | Average areal | Start time of | Start time of | time of | End time of |
| | velocity V1 | velocity V2 | measurement | backflow | backflow | measurement |
| | [mm²/second] | [mm²/second] | [second] | [second] | [second] | [second] |
| Example | 0.27 | 0.18 | 34 | 155 | 180 | 154 |
| 1-1 | | | | | | |
| Comparative | 0.27 | 0.27 | 34 | 120 | 145 | 154 |
| Example 1 | | | | | | |

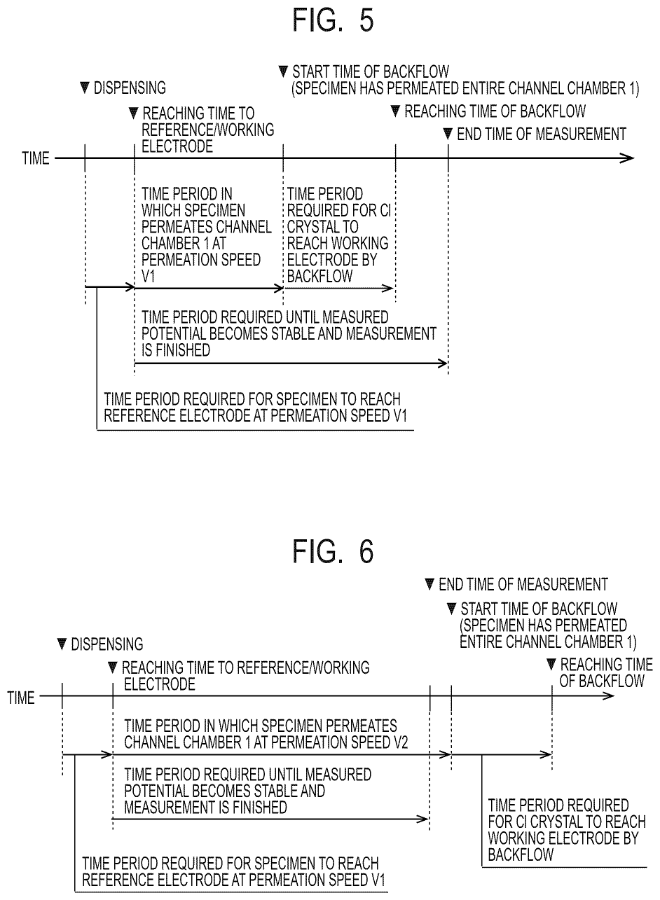

Time superiority in the measurement of the specimen is described with reference to FIG. 5 and FIG. 6.

FIG. 5 is an image diagram for illustrating a behavior of the specimen after the dispensing in Comparative Example.

FIG. 6 is an image diagram for illustrating a behavior of the specimen after the dispensing in this Example.

After the specimen is dispensed to the dispensing section 6, the specimen reaches the reference electrode and the working electrode. After the specimen reaches both the electrodes, a certain time period is required from when the potential on the working electrode side becomes stable and the potential measurement is started to when the measurement is finished. Further, after the specimen reaches the reference electrode, the KCl crystal placed on the upper portion of the reference electrode is dissolved so that the specimen becomes a saturated KCl solution. Thus, the specimen promotes the permeation to the un-permeated region inside of the channel chamber 1 to fill the channel chamber 1. After that, the flow to the un-permeated region stops, and hence the specimen that has become the saturated KCl solution starts to flow backward to the working electrode side to reach the working electrode.

In the micro-analysis chip P11 of Comparative Example 1, the specimen that has become high concentration reached the working electrode before the measurement was finished, and hence a stable measurement value was not able to be obtained. Meanwhile, in the micro-analysis chip P1 of Example 1-1, the time period required from when the specimen reached the reference electrode to when the specimen filled the entire un-permeated region inside of the channel chamber 1 was prolonged. Thus, the measurement was able to be finished before the specimen flowed backward toward the working electrode and reached the working electrode. Accordingly, a stable measurement value was able to be obtained.

As described above, in the configuration of the micro-analysis chip P1, the bent portion 18 was provided so that the average areal velocity in the permeable region of the channel chamber 1 after the specimen has reached the reference electrode 7 was decreased. Thus, the time period required until the specimen filled the channel chamber was prolonged. Accordingly, the measurement was able to be finished before KCl flowing backward reached the working electrode.

### Examples 1-2 to 1-4

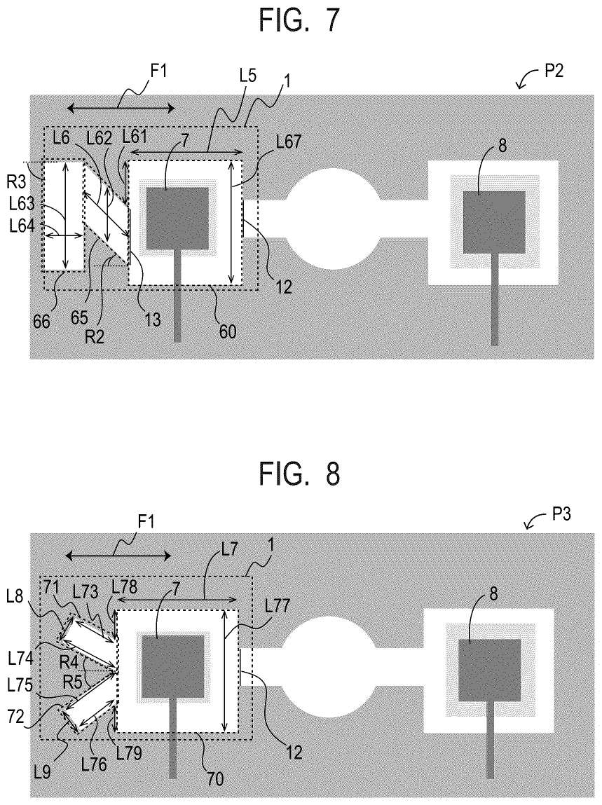

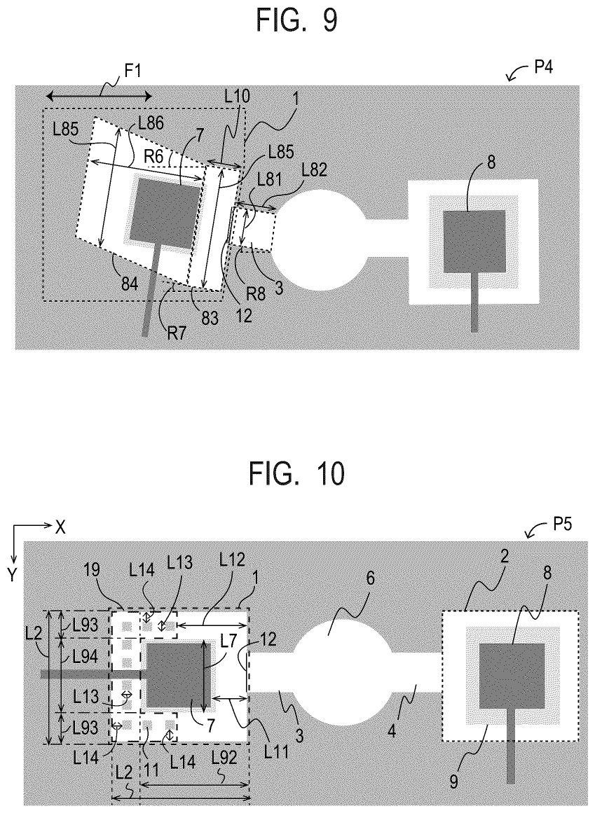

FIG. 7, FIG. 8, and FIG. 9 show micro-analysis chips 2 to 4 according to Examples 1-2 to 1-4, respectively.

The micro-analysis chips 2 to 4 have the same configuration as that of the micro-analysis chip P1 regarding channels and components other than the channel chamber 1. Now, components which are common to the micro-analysis chip P1 are described with common component names.

### Example 1-2

A micro-analysis chip P2 is described with reference to FIG. 7. As illustrated in FIG. 7, a channel chamber 1 of a micro-analysis chip P2 includes a plurality of bent portions. That is, the channel chamber 1 of the micro-analysis chip P2 is bent at a plurality of portions.

The channel chamber 1 includes a rectangular portion 60 having a length L5 and a width L67, a first bent portion 65 of a parallelogram, and a second bent portion 66 of a rectangle. The first bent portion 65 is bent at a position by a distance L5 from the channel connection portion 12, at an angle R2 with respect to the fiber direction F1 when the fiber direction F1 of the porous substrate S1 is regarded as 0°. Further, the second bent portion 66 is bent at a position by a distance L6 from a first bending start portion 13, at an angle R3 with respect to the fiber direction F1.

A distance from an upper left corner of the rectangular portion 60 to an upper end of the first bending start portion 13 is represented by L61.

A width of the first bent portion 65 is represented by L62.

A width of the second bent portion 66 is represented by L63, and a length thereof is represented by L64.

In this Example, L5 was set to 9 mm, L67 was set to 9 mm, R2 was set to 45°, L6 was set to 3 mm, and R3 was set to 90°.

Further, L61 was set to 3 mm, L62 was set to 3 mm, L63 was set to 8 mm, and L64 was set to 3 mm.

Also in the micro-analysis chip P2, similarly to the micro-analysis chip P1, the areal velocity of the specimen T1 is decreased in each bent channel (first bent portion 65 and second bent portion 66), and the average areal velocity V2 of a specimen T1 inside of the channel chamber 1 after the specimen T1 has reached the reference electrode 7 is decreased.

The configuration is only required to decrease the average areal velocity V2 to extend the time period required for KCl flowing backward to reach the working electrode 8 so that the measurement can be performed more stably as compared to the channel configuration having no bent portion, and the position, the number of times, and the angle of the bending of the channel are not limited to the above-mentioned values.

### Example 1-3

A micro-analysis chip P3 is described with reference to FIG. 8. As illustrated in FIG. 8, the channel chamber 1 of the micro-analysis chip P3 includes a plurality of channels extending in different directions.

A channel chamber 1 includes a rectangular portion 70, a first bent portion 71, and a second bent portion 72.

The rectangular portion 70 has a length L7 and a width L77.

A distance from an upper left corner of the rectangular portion 70 to an upper end of a bending start portion of a first bent portion 71 is represented by L78.

The first bent portion 71 is a trapezoid having a height L8, an upper-base length L73, and a lower-base length L74, and is a channel having a width L8 (=height L8) and being bent at an angle R4 with respect to the fiber direction F1, at a position by a distance L7 from the channel connection portion 12.

A distance from a lower left corner of the rectangular portion 70 to a lower end of a bending start portion of a second bent portion 72 is represented by L79.

The second bent portion 72 is a trapezoid having a height L9, an upper-base length L75, and a lower-base length L76, and is a channel having a width L9 (=height L9) and being bent at an angle R5 with respect to the fiber direction F1.

In this Example, L7 was set to 9 mm, L77 was set to 9 mm, R4 was set to 25°, L8 was set to 1 mm, R5 was set to 30°, and L9 was set to 1 mm.

Further, L73 was set to 3 mm, L74 was set to 4 mm, L75 was set to 4 mm, L76 was set to 3 mm, L78 was set to 2.5 mm, and L79 was set to 2.5 mm.

Also in the micro-analysis chip P3, similarly to the micro-analysis chip P1, the areal velocity of the specimen T1 is decreased in two bent and branched channels (first bent portion 71 and second bent portion 72), and the average areal velocity V2 of the specimen T1 inside of the channel chamber 1 after the specimen T1 has reached the reference electrode 7 is decreased.

The configuration is only required to extend the time period required for KCl flowing backward to reach the working electrode 8 so that the measurement can be performed more stably as compared to the channel configuration having no bent portion, and the position and the number of times of the bending of the channel, the angle and the width of the bent channel, and the number of branched channels are not limited to the above-mentioned values.

### Example 1-4

In Examples 1-1 to 1-3, an average value (first average angle r1) of the angle during a period until the specimen reached a reference electrode 7 from a dispensing section 6 is 0 degrees. However, in Example 1-4, an average value (first average angle r1) of an angle during a period until the specimen reaches the reference electrode 7 from the dispensing section 6 is not 0 degrees. In Example 1-4, the relationship of r1<r2 is satisfied although the first average angle r1 is not 0 degrees.

The micro-analysis chip P4 is described with reference to FIG. 9. As illustrated in FIG. 9, in the micro-analysis chip P4, not only the channel chamber 1 but also the channel 3 is bent.

The channel 3 is a rectangle having a width L81 and a length L82, and is bent at an angle R8 with respect to the fiber direction F1.

The channel chamber 1 includes a first bent portion 83 and a second bent portion 84.

The first bent portion 83 is a rectangle having a width L85 and a height L10, and is bent at an angle R7 with respect to the fiber direction F1.

The second bent portion 84 is a parallelogram having a width L85 and a height L86, and is bent at an angle R6 with respect to the fiber direction F1 at a position by a distance L10 (=height L10) from the channel connection portion 12.

In this Example, R7 and R8 were each set to 10°, L10 was set to 4 mm, R6 was set to 30°, L81 was set to 3 mm, L82 was set to 3 mm, L85 was set to 9 mm, and L86 was set to 7 mm.

As compared to the angle (R7 or R8) of bending in the channel (channel 3 and first bent portion 83) before the specimen T1 reaches the reference electrode 7, the angle (R6) of bending of the channel (second bent portion 84) after the specimen T1 has reached the reference electrode 7 is larger. As the bending of the channel with respect to the fiber direction F1 becomes larger, the length of the pore that the specimen T1 is required to permeate by a capillary action becomes larger. Accordingly, as compared to the channel bent at 100 with respect to the fiber direction F1, the channel bent at 30° with respect to the fiber direction F1 has a smaller areal velocity of the specimen T1. Thus, as compared to the average areal velocity V1 of the specimen T1 before the specimen T1 reaches the reference electrode 7, the average areal velocity V2 of the specimen T1 after the specimen T1 has reached the reference electrode 7 is smaller. The configuration is only required to decrease the average areal velocity V2 to extend the time period required for KCl flowing backward to reach the working electrode 8 so that the measurement can be performed more stably as compared to the channel configuration having no bent portion, and the position, the number of times, and the angle of the bending are not limited to the above-mentioned values.

### Example 2

In a micro-analysis chip according to Example 2, a channel in a channel chamber 1 that the specimen is permeable after a specimen has reached a reference electrode 7 from a dispensing section 6 is divided into two regions in which a region closer to the dispensing section 6 is regarded as an upstream region and a region farther from the dispensing section 6 is regarded as a downstream region, and when a sectional area taken along a plane perpendicular to a moving direction of the specimen is regarded as a sectional area of each of the regions, the downstream region has a part in which the sectional area of the downstream region is smaller than the sectional area of the upstream region.

The average areal velocity V1 and the average areal velocity V2 satisfy the relationship of V1>V2 by setting the sectional area of a part of the downstream region to be smaller than the sectional area of the upstream region.

### Example 2-1

A micro-analysis chip P5 according to this Example is described with reference to FIG. 10. A dispensing section 6, a channel 3, a channel 4, a channel chamber 2, a working electrode 8, and an ion-selective membrane 9 of the micro-analysis chip P5 have configurations which are similar to those of the micro-analysis chip P1, and hence description thereof is omitted. Components which are common to the micro-analysis chip P1 are hereinafter described with common component names.

### <Configurations of Channels and Channel Chambers>

The channel pattern was formed as a channel wall that a specimen T1 was impermeable by arranging the hydrophobic resin G1 on the porous substrate S1 and causing the hydrophobic resin G1 to permeate inside of paper by heat fixing. The channel chamber 1 is a square having one side of L2, and includes the reference electrode 7. Ten hydrophobic resin portions 11 were formed in a downstream region 19 of the channel separated away by a distance L12 or more from the channel connection portion 12 inside of the channel chamber 1. The hydrophobic resin portions 11 were each a square having one side of L13, and were arranged at positions separated by a distance L14 from the wall surface of the channel chamber 1 so that an interval between the hydrophobic resin portion 11 and the hydrophobic resin portion 11 became a substantially equal interval.

In a case of the micro-analysis chip P5 illustrated in FIG. 10, the “upstream region” is a “region in which a distance from the channel connection portion 12 is L11 or more and L12 or less in the X direction.”

The “downstream region” is a “region in which a distance from the channel connection portion 12 is L12 or more and L2 or less in the X direction.”

The “downstream region” is further divided into an “upstream part in the downstream region,” a “midstream part in the downstream region,” and a “downstream part in the downstream region.”

The “upstream part in the downstream region” is a “part in which the distance from the channel connection portion 12 is L12 or more and L92 or less in the X direction.”

The “midstream part in the downstream region” is a “part in which the distance from the channel connection portion 12 is L92 or more in the X direction, and a distance from a channel wall surface defining the channel chamber 1, which is parallel to the X axis, is 0 or more and L93 or less.”

The “downstream part in the downstream region” is a “part in which the distance from the channel connection portion 12 is L92 or more in the X direction, and a distance from a channel wall surface defining the channel chamber 1, which is parallel to the X axis, is L93 or more and (L93+L94) or less.”

### <Sectional Area Taken Along Plane Perpendicular to Moving Direction of Specimen in Upstream Region>

In the case of the micro-analysis chip P5 illustrated in FIG. 10, the “moving direction of the specimen” in the “upstream region” is the “X axis direction,” and hence a “sectional area taken along a plane perpendicular to the moving direction of the specimen” is (width L93 of channel)×(thickness L1).

### <Sectional Area Taken Along Plane Perpendicular to Moving Direction of Specimen in Upstream Part in Downstream Region>

The “moving direction of the specimen” in the “upstream part in the downstream region” is also the “X axis direction.” Further, the “sectional area taken along the plane perpendicular to the moving direction of the specimen” in parts in which the hydrophobic resin portions 11 are present is {(width L93 of channel)−(width L13 of hydrophobic resin portion 11)}×(thickness L1).

### <Sectional Area Taken Along Plane Perpendicular to Moving Direction of Specimen in Downstream Part in Downstream Region>

The “moving direction of the specimen” in the “downstream part in the downstream region” is the “Y axis direction.” Further, the “sectional area taken along the plane perpendicular to the moving direction of the specimen” in parts in which the hydrophobic resin portions 11 are present is {(width (L2−L92) of channel)−(width L13 of hydrophobic resin portion 11)}×(thickness L1).

As described above, the downstream region has a part in which the sectional area of the part of the downstream region is smaller than the sectional area of the upstream region.

In this Example, L2 was set to 8 mm, L12 was set to 4 mm, L13 was set to 0.5 mm, L14 was set to 0.5 mm, L92 was set to 7.5 mm, L93 was set to 1.5 mm, and L94 was set to 6 mm.

However, the method of forming the channel wall that the specimen T1 is impermeable is not limited thereto. Further, a shape, a size, a number, and positions of arrangement of the hydrophobic resin portions 11 formed inside of the channel chamber 1 are not limited thereto. Further, the channel chamber 1 is only required to fall within a range of an amount of substance that becomes a saturated solution when the ion crystal 10 is dissolved in pure water having a volume equivalent to a volume C2 of the channel chamber 1 that the specimen T1 is permeable, and the size and the shape of the channel chamber 1 are not limited thereto.

### <Formulation of Electrodes>

The channel chamber 1 includes the reference electrode 7 formed with use of Ag/AgCl as a square having the width L7 of 5 mm, at a position by the distance L11 of 1.5 mm from the channel connection portion 12. The reference electrode 7 has a shape in which, as a contact when measurement is performed, an electrode is continuously extended onto the channel wall 5 from the inside of the channel chamber 1. Further, the KCl ion crystal 10 of 3.5 mg was arranged on the reference electrode 7 inside of the channel chamber 1. As a matter of course, the shape, the size, the material, the arrangement, etc. of the reference electrode 7 are not limited thereto. Further, the material of the ion crystal 10 is not limited thereto within a range including Cl ions, and the mass thereof is not limited thereto within a range of a mass that allows a saturated solution to be obtained when the ion crystal 10 is dissolved in pure water having a volume equivalent to the volume C2.

### <Permeation of Specimen at Time of Measurement>

In the above-mentioned channel pattern, in the channel in which the hydrophobic resin portions 11 are arranged, the sectional area of the channel taken along the plane perpendicular to the moving direction of the specimen T1 is reduced.

The permeation speed of the specimen T1 around the hydrophobic channel wall and around the hydrophobic resin portion (hereinafter also referred to as “around the hydrophobic wall surface, etc.”) is considered. It is understood from the equation (1) that, as the contact angle Θ becomes larger, the time “t” required for permeation by the same distance “h” becomes larger. In view of the above, when the pore wall surface is a hydrophobic resin having a hydrophobic property higher than that of fibers forming the porous substrate, the contact angle is increased, and the time “t” required for permeation is also increased. That is, it is understood that the permeation speed of the specimen T1 is decreased around the hydrophobic wall surface and the like in the channel.

When the sectional area of the channel is large, a ratio of a “flow rate of the specimen T1 whose permeation speed is decreased by the wall surface having a high hydrophobic property” to an “entire flow rate of the specimen T1 flowing into the channel” is small. Accordingly, the wall surface having a high hydrophobic property hardly affects the average areal velocity V2 of the specimen T1 in the entire channel. Meanwhile, when the sectional area of the channel is small, the ratio of the “flow rate of the specimen T1 whose permeation speed is decreased by the wall surface having a high hydrophobic property” to the “entire flow rate of the specimen T1 flowing into the channel” is increased. Accordingly, the reduction of the permeation speed of the specimen T1 in the vicinity of the hydrophobic wall surface, etc. greatly affects the average areal velocity V2 of the specimen T1 inside of the channel, and thus the average areal velocity V2 becomes smaller as compared to a channel having a large sectional area.

Further, in this Example, the plurality of hydrophobic resin portions 11 are provided, and the channel alternately includes a channel portion in which no hydrophobic resin portion 11 is present and the sectional area is large and a channel portion in which the hydrophobic resin portion 11 is present and the sectional area is small.

A relationship between a flow rate Q (m³/second) in the channel and a sectional area S (m²) and a flow velocity V (m/second) of the channel is expressed by following equation.

Q=SV

When the channel portion having a large sectional area is provided after the channel portion having a small sectional area, in the channel portion having a small sectional area S on the upstream side, the flow rate Q is small even at the same flow velocity V, and the flow rate Q in the channel portion having a large sectional area S connected on the downstream side is also small. Accordingly, it is considered that, with the channel having a small sectional area being arranged, the average areal velocity V2 of the specimen T1 is decreased.

In this Example, with the hydrophobic resin portions 11 being arranged, the sectional area is 0.67 times (=(2×L14)/(2×L14+L13)=1.0/1.5) that of a normal channel in which no hydrophobic resin portion 11 is arranged. Accordingly, the flow rate Q is 0.67 times and the areal velocity is also 0.67 times. Further, the flow rate is maintained even when the specimen moves from the channel portion in which the hydrophobic resin portion 11 is arranged and thus the sectional area is small to the normal channel portion in which no hydrophobic resin portion 11 is arranged, and hence the areal velocity is also kept to 0.67 times. When the channel portion in which the hydrophobic resin portion 11 is arranged and thus the sectional area is small is present as described above, the areal velocity becomes 0.67 times the areal velocity immediately before entry to the downstream region 19, and hence the average areal velocity V2 until the channel is filled is decreased.

If no hydrophobic resin portion 11 is arranged in the downstream region 19 in the micro-analysis chip P5, a time period required for the specimen to fill the downstream region 19 in which no hydrophobic resin portion 11 is arranged is 64 seconds. In this case, the average areal velocity V1 in the downstream region 19 in which no hydrophobic resin portion 11 is arranged is about 0.27 [mm²/second].

In contrast, in this Example, the areal velocity of the specimen T1 becomes 0.67 times after the specimen T1 passes through a thin channel, and hence the average areal velocity V2 of the specimen in the downstream region 19 in which the hydrophobic resin portion 11 is arranged is about 0.18 [mm²/second]. Accordingly, a time period of about 96 seconds corresponding to 1.5 times 64 seconds is required for the specimen T1 to fill the downstream region 19.

That is, in this Example, a time period required until the backflow may occur can be extended by about 32 seconds as compared to the channel having the same volume C2.

### Comparative Example 2

A micro-analysis chip (not shown) of Comparative Example 2 was formed to have the same configuration as that of the micro-analysis chip P5 except that no hydrophobic resin portion 11 was arranged.

In this micro-analysis chip, 45 seconds were required from when a specimen T1 reached a channel connection portion 12 to when the specimen T1 reached a reference electrode 7 and a working electrode 8.

About 120 seconds were required from when the measurement was started to when the potential to be measured had less variation and became stable and the measurement was ended.

Meanwhile, 92 seconds were required from when the specimen T1 reached the reference electrode 7 to when the channel chamber 1 was filled.

After the channel chamber 1 was filled, 25 seconds were required until KCl on the reference electrode 7 closest to the working electrode 8 reached the working electrode 8.

That is, 162 (=45+92+25) seconds in total were required from when the specimen T1 reached the channel connection portion 12 to when KCl flowing backward reached the working electrode 8.

However, 165 (=45+120) seconds in total are required from when the specimen T1 reaches the channel connection portion 12 to when the measurement is ended.

That is, in the micro-analysis chip of Comparative Example 2, the KCl concentration slightly changed in the working electrode 8 before the potential was stabilized and the measurement was ended, and thus the measurement was not able to be accurately performed.

Meanwhile, in the micro-analysis chip P5 of Example 2-1, the hydrophobic resin portions 11 are arranged so that the time period required for the specimen T1 to fill the channel chamber 1 is extended by about 32 seconds, and thus the specimen T1 fills the channel chamber 1 after an elapse of about 124 seconds from when the specimen T1 has reached the reference electrode 7. Accordingly, the time period required for KCl flowing backward to reach the working electrode 8 is about 194 seconds after the specimen T1 has reached the channel connection portion 12. That is, the measurement can be ended before KCl flowing backward reaches the working electrode 8.

Table 2 shows the average areal velocity, an end time of measurement, a reaching time of backflow, etc. in Example 2-1 and Comparative Example 2.

TABLE 2

| | | | | | Reaching | |
|---|---|---|---|---|---|---|
| | Average areal | Average areal | Start time of | Start time of | time of | End time of |
| | velocity V1 | velocity V2 | measurement | backflow | backflow | measurement |
| | [mm²/second] | [mm²/second] | [second] | [second] | [second] | [second] |
| Example | 0.27 | 0.18 | 45 | 169 | 194 | 165 |
| 2-1 | | | | | | |
| Comparative | 0.27 | 0.27 | 45 | 137 | 162 | 165 |
| Example 2 | | | | | | |

From a relationship between the sectional area in which the specimen T1 is permeable and a flow velocity decrease rate, the channel sectional area generated in the channel in which the hydrophobic resin portion 11 is arranged is required to be from 10% to 80% with respect to the channel sectional area before the hydrophobic resin portion 11 is arranged, and is preferably from 40% to 50%.

### Examples 2-2 to 2-4

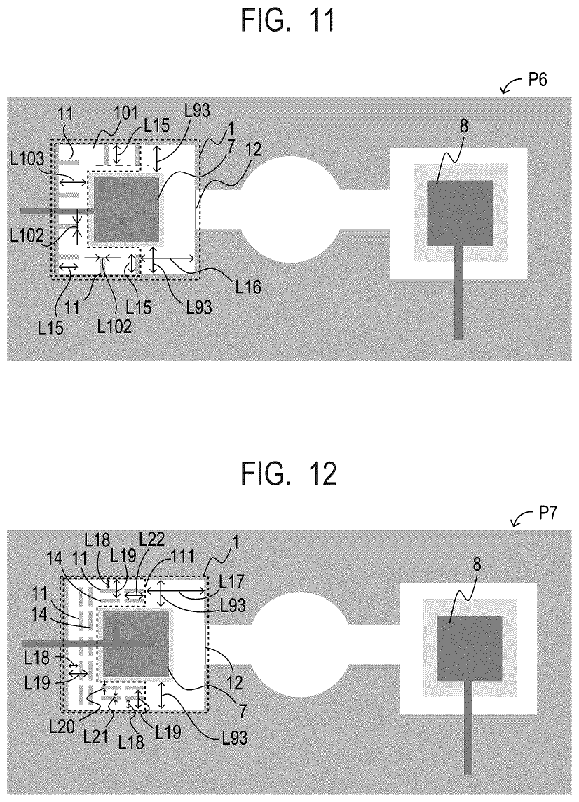

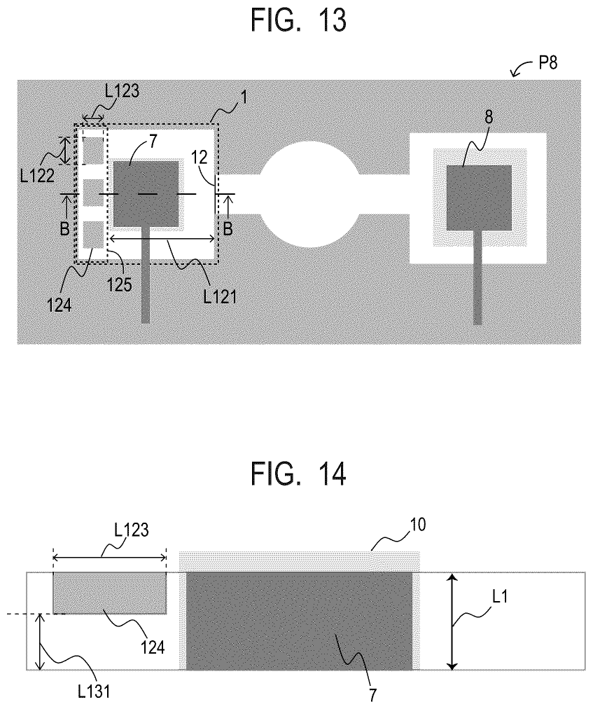

FIG. 11, FIG. 12, and FIG. 13 and FIG. 14 show micro-analysis chips P6 to P8 according to Examples 2-2 to 2-4, respectively.

The micro-analysis chips P6 to P8 have the same configuration as that of the micro-analysis chip P5 regarding channels and components other than the hydrophobic resin portion 11. Now, components which are common to the micro-analysis chip P5 are described with common component names.

### Example 2-2

The micro-analysis chip P6 is described with reference to FIG. 11. In a region 101 on a channel downstream separated away by a distance L16 or more from a channel connection portion 12 inside of the channel chamber 1, eight hydrophobic resin portions 11 each having a width L15 and a length L102 were formed at positions at each of which one end of the hydrophobic resin portion 11 is in contact with the channel wall. The hydrophobic resin portions 11 were each arranged so that a long-side direction of the hydrophobic resin portion 11 perpendicularly intersected with the wall surface of the channel wall. With the hydrophobic resin portions 11 being arranged, the width of the channel in the region 101 in which the hydrophobic resin portions 11 are arranged reduces from L93 to (L93-L15).

In this case, L16 is set to 4 mm, L15 is set to 0.5 mm, and L102 is set to 0.3 mm. However, a shape, a size, and a number of the hydrophobic resin portions 11 are not limited thereto. Also in the micro-analysis chip P6, the sectional area of the channel in which the hydrophobic resin portion 11 is arranged is reduced by decreasing the width of the channel, and hence the average areal velocity V2 of a specimen T1 after the specimen T1 has reached the reference electrode 7 is decreased. Thus, the time period required for KCl flowing backward to reach the working electrode 8 is extended, and the measurement can be performed more stably as compared to the channel configuration having no hydrophobic resin portion 11.

### Example 2-3

The micro-analysis chip P7 is described with reference to FIG. 12. In a region 111 on a channel downstream separated away by a distance L17 or more from a channel connection portion 12 inside of the channel chamber 1, nine hydrophobic resin portions 11 each having a width L21 and a length L22 were formed at positions separated away by a distance L18 from the wall surface of the channel chamber. Further, nine hydrophobic resin portions 14 each having a width L20 and a length L22 were formed at positions separated away by a distance L19 from the wall surface of the channel chamber, on the same plane as that of each of the above-mentioned hydrophobic resin portions 11, which is perpendicular to the moving direction of the channel. With the hydrophobic resin portions 11 and the hydrophobic resin portions 14 being arranged, the width of the channel of the region 111 reduces from L93 to (L93−L20−L21).

In this Example, L17 was set to 4 mm, L18 was set to 0.1 mm, L19 was set to 0.5 mm, L20 was set to 0.1 mm, L21 was set to 0.1 mm, and L22 was set to 0.5 mm. However, a shape, a size, and a number of the hydrophobic resin portions 11 and the hydrophobic resin portions 14 are not limited thereto. Also in a case of the micro-analysis chip P7, the sectional area of the channel in which the hydrophobic resin portion 11 and the hydrophobic resin portion 14 are arranged is reduced by decreasing the width of the channel, and hence the average areal velocity V2 of a specimen T1 after the specimen T1 has reached the reference electrode 7 is decreased. Thus, the time period required for KCl flowing backward to reach the working electrode 8 is extended, and the measurement can be performed more stably as compared to the channel configuration having no hydrophobic resin portion 11 and no hydrophobic resin portion 14.

### Example 2-4

A micro-analysis chip P8 is described with reference to FIG. 13 and FIG. 14. FIG. 13 is a top view of the micro-analysis chip P8, and FIG. 14 is a sectional view in the cross section B-B of the channel chamber 1 of the micro-analysis chip P8. In the micro-analysis chip P8, in a region 125 on a channel downstream separated away by a distance L121 from a channel connection portion 12 inside of a channel chamber 1, three hydrophobic resin portions 124 each having a width L122 and a length L123 were formed at positions by a distance L131 from a bottom surface of a porous substrate S1. In this case, L121 is set to 6.5 mm, L122 is set to 0.5 mm, L123 is set to 1.0 mm, and L131 is set to 0.04 mm. However, a shape, a size, and a number of the hydrophobic resin portions 124 are not limited thereto. Also in a case of the micro-analysis chip P8, the sectional area of the channel in which the hydrophobic resin portion 124 is arranged is reduced, and hence the average areal velocity V2 of a specimen T1 after the specimen T1 has reached the reference electrode 7 is decreased. Thus, the time period required for KCl flowing backward to reach the working electrode 8 is extended, and the measurement can be performed more stably as compared to the channel configuration having no hydrophobic resin portion 124.

### Example 3

In a micro-analysis chip P9 according to Example 3, a porous substrate S2 is an anisotropic porous substrate including a plurality of pores and having a non-isotropic shape in which a major axis and a minor axis of a permeation shape being an ellipse formed in a porous substrate to which a specimen is dispensed can be defined.

In addition, when an average pore radius of the porous substrate S2 in a channel 3 and a channel chamber 1 until the specimen reaches a reference electrode 7 from a dispensing section 6 is represented by A1, and an average pore radius of the porous substrate S2 in the channel chamber 1 after the specimen has reached the reference electrode 7 is represented by A2, the average pore radius A1 and the average pore radius A2 satisfy a relationship of A1>A2.

The average areal velocity V1 and the average areal velocity V2 satisfy the relationship of V1>V2 by setting the average pore radius A1 and the average pore radius A2 to satisfy the relationship of A1>A2.

### <Average Pore Radius>

The “average pore radius” refers to, when the pore radius changes depending on a region, as a region having the pore radius of a first pore radius, a region having the pore radius of a second pore radius, . . . , a region having the pore radius of an n-th pore radius (“n” is any natural number), an average value of those pore radiuses.

Specifically, when a volume of a region having the pore radius of Rp1 is represented by Vp1, a volume of a region having the pore radius of Rp2 is represented by Vp2, . . . , a volume of a region having the pore radius of Rpn is represented by Vpn, an average pore radius Rpavg is calculated by the following equation:

$$Rp avg = \{ Rp 1 \times Vp 1 / ( Vp 1 + Vp 2 + ⋯ + Vpn ) \} + \{ Rp 2 \times Vp 2 / ( Vp 1 + Vp 2 + ⋯ + Vpn ) \} + ⋯ + \{ Rpn \times Vpn / ( Vp 1 + Vp 2 + ⋯ + Vpn ) \} .$$

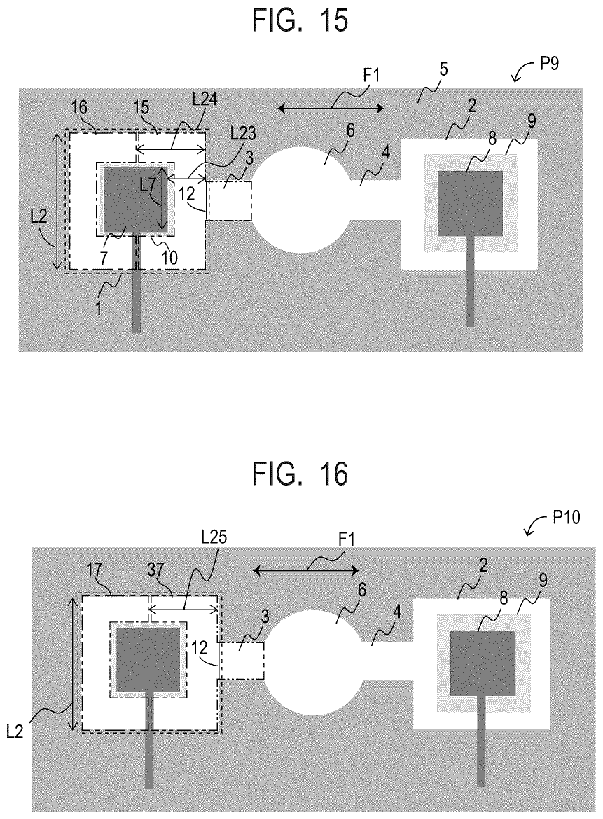

A micro-analysis chip P9 according to Example 3 is described with reference to FIG. 15. Further, a dispensing section 6, a channel 3, a channel 4, a channel chamber 2, a working electrode 8, and an ion-selective membrane 9 have configurations which are similar to those of the micro-analysis chip P1, and hence description thereof is omitted. Components which are common to the micro-analysis chip P1 are hereinafter described with common component names.

A pressure was externally applied to a paper-made porous substrate having anisotropy and having the pore radius A1 of 6 μm so that the porous substrate S2 in which the pore radius A2 of a partial region (region 16) was 2 μm was formed, and the micro-analysis chip P9 was formed on this porous substrate S2. However, the pore radius A1 and the pore radius A2 are not limited to those values, and the pore radius within the same substrate may continuously change. The method of changing the pore radius is not limited to external pressure application. Further, the porous substrate S2 is not limited to paper. The porous substrate S2 may have therein a porous structure, such as an open cell structure or a network structure including a nanofiber structure, and may be formed with use of resin, glass, an inorganic substrate, cloth, metal paper, or the like as long as the porous substrate S2 is configured to cause a capillary action with respect to liquid.

### <Configurations of Channels>

A channel pattern was formed as a channel wall that the specimen T1 was impermeable by forming the hydrophobic resin G1 on the porous substrate S2 and causing the hydrophobic resin G1 to permeate inside of paper by heat fixing. The channel pattern includes the dispensing section 6 to which the specimen T1 is caused to adhere, the channel chamber 1 including a reference electrode 7 and being a square having a width L2 of 9 mm, and the channel chamber 2 including the working electrode 8, and further includes the channel 1 connecting the dispensing section 6 and the channel chamber 1 to each other and the channel 2 connecting the dispensing section 6 and the channel chamber 2 to each other.

In the channel chamber 1, the channels were arranged so that: the pore radius A1 in a region 15 (including the channel 3) which is closer to the dispensing section 6 within a distance L24 from the channel connection portion 12 was 6 km; and the pore radius A2 in the region 16 which is farther from the dispensing section 6 beyond the distance L24 from the channel connection portion 12 was 2 km. At this time, L24 was set to 4.5 mm.

However, the method of forming the channel wall that the specimen T1 is impermeable is not limited thereto. Further, the channel chamber 1 falls within a range of an amount of substance that becomes a saturated solution when the ion crystal 10 is dissolved in pure water having a volume equivalent to a volume C3 of the channel chamber 1 that the specimen T1 is permeable, and a size and a shape of the channel chamber 1 are not limited thereto. Further, a radius of the pore is not limited thereto within a range of A1>A2, and the distance L24 is also not limited thereto.

### <Formulation of Electrodes>

The channel chamber 1 includes the reference electrode 7 formed with use of Ag/AgCl as a square having the width L7 of 5 mm, at a position by the distance L23 of 1 mm from the channel connection portion 12. The reference electrode 7 has a shape in which, as a contact when measurement is performed, the electrode is continuously extended onto the channel wall 5 from the inside of the channel chamber 1. Further, the KCl ion crystal 10 of 3.5 mg was arranged on the reference electrode 7 inside of the channel chamber 1. A shape, a size, a material, an arrangement, etc. of the reference electrode 7 are not limited thereto. Further, the material of the ion crystal 10 is only required to include Cl ions, and is not limited to KCl, and the mass of the ion crystal 10 is only required to be a mass that allows a saturated solution to be obtained when the ion crystal 10 is dissolved in pure water having a volume equivalent to the volume C3, and is not limited to the above-mentioned values.

### <Permeation of Specimen at Time of Measurement>

An air gap between the fibers in the porous substrate is regarded as a pore. In Example 3, a pore radius A2 in a region 16 is 0.33 times smaller than a pore radius A1 of a region 15. With reference to the equation (1), as a radius “a” of the pore becomes smaller, a distance “h” of permeation caused by the capillary action per certain time period becomes smaller. Accordingly, in a region having a small pore radius, the permeation speed in each pore is decreased, and thus the areal velocity of the specimen T1 is decreased. In the region 16 of Example 3, the pore radius becomes 0.33 times smaller than the pore radius of the region 15, and hence a distance of permeation caused by a capillary action in a certain time period becomes about 0.58 times smaller. Accordingly, the specimen permeation speed inside of each pore becomes 0.58 times smaller, and the areal velocity also becomes 0.58 times smaller.

A time period of 60 seconds is required until a channel having the same volume as that of the region 16 and having the pore radius A1 is filled. In this case, the average areal velocity V1 in the channel 15 which is not subjected to pressure application is about 0.27 [mm²/second]. In contrast, in Example 3, the areal velocity is 0.58 times smaller. Thus, the average areal velocity V2 is about 0.15 [mm²/second], and the time period required for permeation is about 104 seconds corresponding to 1.73 times larger. In the channel configuration of Example 3, as compared to the channel configuration having the pore radius A1 in the entire region (region 15 and region 16), the time period required until KCl flowing backward reaches the working electrode 8 can be extended by about 44 seconds.

In the micro-analysis chip P11 of Comparative Example 1, about 120 seconds are required from when the specimen T1 reaches the reference electrode 7 and the working electrode 8 and the measurement is started to when the measurement is ended. Meanwhile, the specimen T1 filled the channel chamber 1 after an elapse of 86 seconds from when the specimen T1 reached the reference electrode 7. After the channel chamber 1 was filled with the specimen T1, 25 seconds were required until KCl on the reference electrode 7 closest to the working electrode 8 flowed backward toward the working electrode 8 and reached the working electrode 8. After the specimen T1 reached the channel connection portion 12, 154 seconds in total were required until the measurement was ended, but KCl flowing backward reached the working electrode 8 after 145 seconds in total. Accordingly, the KCl concentration in the working electrode 8 slightly changed before the measurement was ended, and thus the measurement was not able to be performed accurately.

In Example 3, the pore radius is changed so that the time period required for the specimen T1 to fill the channel chamber 1 is extended by about 44 seconds, and thus the specimen T1 fills the channel chamber 1 after an elapse of 134 seconds from when the specimen T1 has reached the reference electrode 7. Accordingly, KCl flowing backward reaches the working electrode 8 after an elapse of 189 seconds from when the specimen T1 reaches the channel connection portion 12. Thus, the measurement can be ended while a stable condition is maintained, before KCl flows backward to reach the working electrode 8.

Table 3 shows the average areal velocity, an end time of measurement, a reaching time of backflow, etc. in Example 3 and Comparative Example 1.

TABLE 3

| | | | | | Reaching | |
|---|---|---|---|---|---|---|
| | Average areal | Average areal | Start time of | Start time of | time of | End time of |
| | velocity V1 | velocity V2 | measurement | backflow | backflow | measurement |
| | [mm²/second] | [mm²/second] | [second] | [second] | [second] | [second] |
| Example 3 | 0.27 | 0.15 | 34 | 164 | 189 | 154 |
| Comparative | 0.27 | 0.27 | 34 | 120 | 145 | 154 |
| Example 1 | | | | | | |

### Example 4

In a micro-analysis chip P10 according to Example 4, a porous substrate S3 is an anisotropic porous substrate including a plurality of pores and having a non-isotropic shape in which a major axis and a minor axis of a permeation shape being an ellipse formed in the porous substrate to which a specimen is dispensed can be defined.

In addition, when an average contact angle of a pore wall surface of a porous substrate S3 in a channel 3 and a channel chamber 1 until the specimen reaches a reference electrode 7 from a dispensing section 6 is represented by Θ1, and an average contact angle of the pore wall surface of the porous substrate S3 in the channel chamber 1 after the specimen has reached the reference electrode 7 is represented by Θ2, the average contact angle Θ1 and the average contact angle Θ2 satisfy a relationship of Θ1<Θ2.

The average areal velocity V1 and the average areal velocity V2 satisfy the relationship of V1>V2 by setting the average contact angle Θ1 and the average contact angle Θ2 to satisfy the relationship of Θ1<Θ2.

### <Average Contact Angle>

The “average contact angle” refers to, when the contact angle changes depending on a region, as a region having the contact angle of a first contact angle, a region having the contact angle of a second contact angle, . . . , a region having the contact angle of an n-th contact angle (“n” is any natural number), an average value of those contact angles.

Specifically, when a volume of a region having the contact angle of Θc1 is represented by Vp1, a volume of a region having the contact angle of Θc2 is represented by Vp2, . . . , a volume of a region having the contact angle of Θcn is represented by Vpn, an average contact angle Θcavg is calculated by the following equation:

$$Θ c avg = \{ Θ c 1 \times Vp 1 / ( Vp 1 + Vp 2 + ⋯ + Vpn ) \} + \{ Θ c 2 \times Vp 2 / ( Vp 1 + Vp 2 + ⋯ + Vpn ) \} + ⋯ + \{ Θ cn \times Vpn / ( Vp 1 + Vp 2 + ⋯ + Vpn ) \} .$$

Further, the “contact angle of the pore wall surface” refers to an angle formed between, when liquid is dropped to a surface of a substrate formed with use of only the same processing and the same material as a material forming the pore in the region having the n-th contact angle, a tangent line of the liquid droplet and the substrate surface.

A micro-analysis chip P10 according to Example 4 is described with reference to FIG. 16. A dispensing section 6, a channel 3, a channel 4, a channel chamber 2, a reference electrode 7, a working electrode 8, and a ion-selective membrane 9 have configurations which are similar to those of the micro-analysis chip P9, and hence description thereof is omitted. Components which are common to the micro-analysis chip P9 are hereinafter described with common component names.

A paper-made porous substrate having anisotropy and the contact angle Θ1 of the pore wall surface of 60° was subjected to coating using a fluorine-based material, etc. so that a porous substrate S3 in which the contact angle Θ2 of the pore wall surface in a partial region (region 17) was 80° was formed. A micro-analysis chip P10 was formed on this porous substrate S3.

However, the porous substrate S3 is not limited to paper. The porous substrate S3 may have therein a porous structure, such as an open cell structure or a network structure including a nanofiber structure, and may be formed with use of resin, glass, an inorganic substrate, cloth, metal paper, or the like as long as the porous substrate S3 is configured to cause a capillary action with respect to liquid. Further, the contact angle Θ1 of the pore wall surface and the contact angle Θ2 of the pore wall surface in the porous substrate S3 are 0°≤Θ1<90° and 0°≤Θ2<90° from a viewpoint of causing the capillary action. The contact angle Θ1 and the contact angle Θ2 are only required to satisfy Θ1<Θ2, and are not limited to the above-mentioned values. The pore radius within the same substrate may continuously change. A method of changing the contact angle of the pore wall surface is not limited to coating using a fluorine-based material, and plasma processing, UV processing, or other types of processing may be used.

### <Configurations of Channels>

The channel pattern was formed as a channel wall that the specimen T1 was impermeable by forming the hydrophobic resin G1 on the porous substrate S3 and causing the hydrophobic resin G1 to permeate inside of paper by heat fixing. The channel pattern includes a dispensing section 6 to which the specimen T1 is caused to adhere, a channel chamber 1 including a reference electrode 7 and being a square having a width L2 of 9 mm, and a channel chamber 2 including a working electrode 8, and further includes a channel 1 connecting the dispensing section 6 and the channel chamber 1 to each other and a channel 2 connecting the dispensing section 6 and the channel chamber 2 to each other.

In the channel chamber 1, the channels were arranged so that: the contact angle Θ1 of the fiber of the porous substrate in a region 37 (including the channel 3) closer to the dispensing section 6 with respect to a distance L25 from the channel connection portion 12 was 60°; and the contact angle Θ2 of the fiber of the porous substrate in a region 17 farther from the dispensing section 6 with respect to the distance L25 from the channel connection portion 12 was 80°. At this time, L25 was set to 4.5 mm.

However, a method of forming the channel wall that the specimen T1 is impermeable is not limited thereto. Further, the channel chamber 1 falls within a range of an amount of substance that becomes a saturated solution when the ion crystal 10 is dissolved in pure water having a volume equivalent to a volume C4 of the channel chamber 1 that the specimen T1 is permeable, and a size and a shape are not limited thereto. Further, the distance L25 is also not limited thereto.

<Permeation of Specimen when Measurement is Performed>

An air gap between the fibers in the porous substrate S3 is regarded as a pore. In Example 4, the contact angle Θ2 of the fiber corresponding to the wall surface of the pore in the region 17 is larger than the contact angle Θ1 of the fiber in another region 37. With reference to the equation (1), as the contact angle becomes larger, a distance “h” of permeation caused by the capillary action in a certain time period becomes smaller. Accordingly, in a range having a large contact angle, the permeation speed in each pore is decreased, and thus the areal velocity of the specimen T1 is decreased. In Example 4, the contact angle Θ1 of the fiber in the region 37 is 60°, while the contact angle Θ2 of the fiber in the region 17 is 80°. Thus, the distance of permeation caused by the capillary action in a certain time period becomes about 0.59 times smaller. Accordingly, the specimen permeation speed inside of each pore becomes 0.59 times smaller, and the areal velocity also becomes 0.59 times smaller.

A time period of 60 seconds is required until a channel having a contact angle of the fiber of 60° and having a same volume as that of the region 17 is filled. In this case, the average areal velocity V1 in the channel having the contact angle of the fiber of 60° is about 0.27 [mm²/second]. In contrast, in Example 4, the areal velocity becomes 0.59 times smaller in the region 17, and the average areal velocity V2 is about 0.16 [mm²/second]. Thus, the time period required for permeation becomes about 102 seconds corresponding to 1.70 times larger. Accordingly, in the channel configuration of Example 4, as compared to the channel configuration in which the contact angle Θ1 is 60° in the entire region, the time period required for KCl flowing backward to reach the working electrode 8 can be extended by about 42 seconds.

In the device of Comparative Example 1 in which the contact angle of the fiber is 60° in the entire region, about 120 seconds are required from when the specimen T1 reaches the reference electrode 7 and the working electrode 8 and the measurement is started to when the measurement is ended. Meanwhile, the specimen T1 filled the channel chamber 1 after an elapse of about 86 seconds from when the specimen reached the reference electrode 7. After the channel chamber 1 was filled with the specimen T1, 25 seconds were required until KCl on the reference electrode 7 closest to the working electrode 8 flowed backward toward the working electrode 8 and reached the working electrode 8. Accordingly, after the specimen T1 reached the channel connection portion 12, 154 seconds in total were required until the measurement was ended, but KCl flowing backward reached the working electrode 8 after 145 seconds in total. Accordingly, the KCl concentration in the working electrode 8 slightly changed before the measurement was ended, and thus the measurement was not able to be performed accurately.

In Example 4, the contact angle of the fiber is changed so that the time period required until the channel chamber 1 is filled is extended by about 42 seconds, and thus the specimen T1 fills the channel chamber 1 after an elapse of 132 seconds from when the specimen T1 has reached the reference electrode 7. Accordingly, KCl flowing backward reaches the working electrode 8 after an elapse of 191 seconds from when the specimen T1 reaches the channel connection portion 12. Thus, the measurement can be ended while the stable condition is maintained, before KCl flows backward to reach the working electrode 8.

Table 4 shows the average areal velocity, an end time of measurement, a reaching time of backflow, etc. in Example 4 and Comparative Example 1.

TABLE 4

| | | | | | Reaching | |
|---|---|---|---|---|---|---|
| | Average areal | Average areal | Start time of | Start time of | time of | End time of |
| | velocity V1 | velocity V2 | measurement | backflow | backflow | measurement |
| | [mm²/second] | [mm²/second] | [second] | [second] | [second] | [second] |
| Example 4 | 0.27 | 0.16 | 34 | 166 | 191 | 154 |
| Comparative | 0.27 | 0.27 | 34 | 120 | 145 | 154 |
| Example 1 | | | | | | |

According to the one aspect of the present disclosure, it is possible to provide the micro-analysis chip with which influence on the working electrode due to backflow of ions from the reference electrode to the working electrode can be suppressed and stable ion concentration measurement can be performed without increasing the chip size or prolonging the measurement time.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. A micro-analysis chip comprising a porous substrate having provided therein a channel wall, the channel wall forming:
a dispensing section to which a specimen is to be dispensed;
a first channel chamber;
a second channel chamber;
a first channel connecting the dispensing section and the first channel chamber to each other; and
a second channel connecting the dispensing section and the second channel chamber to each other,
wherein the first channel chamber has a reference electrode arranged therein and the reference electrode has a surface on which an ion crystal having specimen solubility is arranged,
wherein the second channel chamber has a working electrode arranged therein, and
wherein the micro-analysis chip is configured so that, when an average areal velocity which is an area of a region that the specimen has permeated per unit time in a surface of the porous substrate during a period until the dispensed specimen reaches the reference electrode is represented by V1, and
when an average areal velocity which is an area of a region that the specimen has permeated per unit time in the surface of the porous substrate during a period until the dispensed specimen fills an inside of the first channel chamber after the dispensed specimen has reached the reference electrode is represented by V2,
the average areal velocity V1 and the average areal velocity V2 satisfy a relationship of V1>V2.

2. The micro-analysis chip according to claim 1,
wherein the porous substrate has permeation anisotropy,
wherein, when the specimen is dispensed to the porous substrate in which the channel wall is not formed, a permeation shape formed on the surface of the porous substrate by the dispensed specimen is an ellipse, and a major axis direction of the ellipse is regarded as a fiber direction of the porous substrate, and
wherein, when the fiber direction and a moving direction of the specimen form an angle “r” (0°≤r≤90°),
when an average value of an angle during a period until the specimen reaches the reference electrode from the dispensing section is represented by a first average angle r1, and
when an average value of an angle after the specimen has reached the reference electrode is represented by a second average angle r2,
the first average angle r1 and the second average angle r2 satisfy a relationship of r1<r2.

3. The micro-analysis chip according to claim 1,
wherein a channel in the first channel chamber that the specimen is permeable after the specimen has reached the reference electrode from the dispensing section is divided into two regions in which a region closer to the dispensing section is regarded as an upstream region and a region farther from the dispensing section is regarded as a downstream region, and
wherein, when a sectional area taken along a plane perpendicular to a moving direction of the specimen is regarded as a sectional area of each of the regions,
the downstream region has a part in which the sectional area of the downstream region is smaller than the sectional area of the upstream region.

4. The micro-analysis chip according to claim 1,
wherein the porous substrate includes a plurality of pores,
wherein the porous substrate is an anisotropic porous substrate in which a permeation shape formed in the porous substrate when the specimen is dispensed exhibits a non-isotropic ellipse shape for which a major axis and a minor axis are definable, and
wherein, when an average pore radius of the porous substrate in a channel until the specimen reaches the reference electrode from the dispensing section is represented by A1, and an average pore radius of the porous substrate in a channel after the specimen has reached the reference electrode is represented by A2,
the average pore radius A1 and the average pore radius A2 satisfy a relationship of A1>A2.

5. The micro-analysis chip according to claim 1,
wherein the porous substrate includes a plurality of pores,
wherein the porous substrate is an anisotropic porous substrate in which a permeation shape formed in the porous substrate when the specimen is dispensed exhibits a non-isotropic ellipse shape for which a major axis and a minor axis are definable, and
wherein, when an average contact angle of a pore wall surface of the porous substrate in a channel until the specimen reaches the reference electrode from the dispensing section is represented by Θ1, and an average contact angle of the pore wall surface of the porous substrate in a channel after the specimen has reached the reference electrode is represented by Θ2,
the average contact angle Θ1 and the average contact angle Θ2 satisfy a relationship of Θ1<Θ2.
